(19) United States
(12) Patent Application Publication
(10) Pub. No.: US 2007/0147082 A1
(43) Pub. Date: Jun. 28, 2007

(54) Backlight module with light tubes having specially aligned electrodes and liquid crystal display with same

(75) Inventors: Yu-Ju Hsu, Miao-Li (TW); Yung-Chiang Cheng, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/641,919

(22) Filed: Dec. 19, 2006

(30) Foreign Application Priority Data
Dec. 23, 2005 (TW) 94146277

(51) Int. Cl. F21V 7/04

(52) U.S. Cl. 362/613; 362/614

(57) ABSTRACT

An exemplary backlight module (10) includes a light guide plate (12), a first light tube (14) and a second light tube (14) located adjacent to the light guide plate. Each of the light tubes includes a first electrode (142) configured to be electrically connected with a high voltage electricity source, and a second electrode (144) configured to be electrically connected with a low voltage electricity source. Either the first electrode of the first light tube is positioned adjacent to the second electrode of the second light tube, or, the first electrode of the first light tube is positioned at one side of the light guide plate and the second electrode of the second light tube is positioned at an opposite side of the light guide plate with the first electrode being directly across from the second electrode.

### FIELD OF THE INVENTION

The present invention relates to backlight modules such as those used in liquid crystal displays (LCDs), and more particularly to a backlight module with at least two light tubes having electrodes thereof positioned complementary to each other.

### GENERAL BACKGROUND

Liquid crystal displays are commonly used as displays for compact electronic apparatuses, because they not only provide good quality images with little power but are also very thin. The liquid crystal in a liquid crystal display does not emit any light itself. The liquid crystal has to be lit by a light source so as to clearly and sharply display text and images. Thus, a backlight module is generally needed for a liquid crystal display.

Referring to FIG. 7 and FIG. 8, a typical backlight module 70 includes a light guide plate (LGP) 72, a pair of light tubes 74, and a printed circuit board (PCB) 76. The light guide plate 72 includes a light incident surface 722, and a bottom surface 724 perpendicularly connected with the light incident surface 722. The light tubes 74 are located adjacent to the light incident surface 722 in parallel, and are linear cold cathode fluorescent lamps (CCFLs). Each light tube 74 includes a first electrode 742, and a second electrode 744 opposite to the first electrode 742. The printed circuit board 76 is located adjacent to the bottom surface 724 of the light guide plate 72, and includes a pair of transformers 762 and a pulse-width modulator (PWM) 764.

The light tubes 74 are electrically connected with the printed circuit board 76. The first electrodes 742 are electrically connected with the respective transformers 762 which provide high voltage electricity to the first electrodes 742. The first electrodes 742 are aligned parallel to each other. The second electrodes 744 of the light tubes 74 are electrically connected with the PMW 764, which provides low voltage electricity to the second electrodes 744. The second electrodes 744 are aligned parallel to each other.

When each light tube 74 is in a working state, mercury vapor in the light tube 74 is concentrated around the first electrode 742. Therefore, brightness and heat generation around the first electrode 742 of the light tube 74 are higher than those around the second electrode 744 of the light tube 74. That is, the light tube 74 has non-uniform emission of light and non-uniform temperature distribution. Because the first electrodes 742 of the light tubes 74 are aligned with each other, the uniformity of light output by the backlight module 70 is liable to be degraded. Furthermore, the uneven temperature distribution may shorten the working life of each light tube 74.

What is needed, therefore, is a backlight module that can overcome the above-described deficiencies. What is also needed is a liquid crystal display employing such a backlight module.

### SUMMARY

In one preferred embodiment, a backlight module includes a light guide plate, a first light tube and a second light tube located adjacent to the light guide plate. Each of the light tubes includes a first electrode configured to be electrically connected with a high voltage electricity source, and a second electrode configured to be electrically connected with a low voltage electricity source. Either the first electrode of the first light tube is positioned adjacent to the second electrode of the second light tube, or, the first electrode of the first light tube is positioned at one side of the light guide plate and the second electrode of the second light tube is positioned at an opposite side of the light guide plate with the first electrode being directly across from the second electrode.

Other aspects, advantages and novel features will become more apparent from the following detailed description when taken in conjunction with the accompanying drawings.

### BRIEF DESCRIPTION OF THE DRAWINGS

The components in the drawings are not necessarily drawn to scale, the emphasis instead being placed upon clearly illustrating the principles of the described embodiments. In the drawings, like reference numerals designate corresponding parts throughout various views, and all the views are schematic.

FIG. 1 is an exploded, isometric view of a backlight module according to a first embodiment of the present invention.

FIG. 2 is a block diagram showing components and circuitry of the backlight module of FIG. 1.

FIG. 3 is an isometric view of a backlight module according to a second embodiment of the present invention.

FIG. 4 is a top-down, plan view of a backlight module according to a third embodiment of the present invention.

FIG. 5 is a top-down, plan view of a backlight module according to a fourth embodiment of the present invention.

FIG. 6 is an exploded, side view of a liquid crystal display according to an exemplary embodiment of the present invention, the liquid crystal display including the backlight module of FIG. 1.

FIG. 7 is an exploded, isometric view of a conventional backlight module.

FIG. 8 is a block diagram showing components and circuitry of the backlight module of FIG. 7.

### DETAILED DESCRIPTION OF PREFERRED EMBODIMENTS

Reference will now be made to the drawings to describe the preferred embodiments in detail.

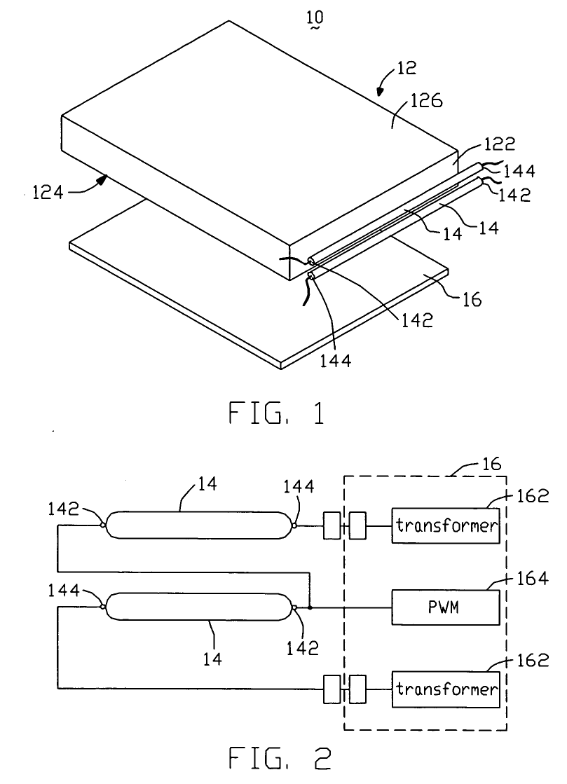

Referring to FIG. 1, a backlight module 10 according to a first embodiment of the present invention is shown. The backlight module 10 includes a light guide plate 12, a pair of light tubes 14, and a printed circuit board 16.

The light guide plate 12 includes a light incident surface 122, a bottom surface 124 perpendicularly connected with the light incident surface 122, and a light emitting surface 126 on an opposite side of the light guide plate to the bottom surface 124. The light tubes 14 are located adjacent to the light incident surface 122 of the light guide plate 12 and serve as a light source for the backlight module 10. In the illustrate embodiment, the light tubes 14 are linear CCFLs; and each light tube 14 includes a first electrode 142 and a second electrode 144 opposite to the first electrode 142. Referring also to FIG. 2, the printed circuit board 16 is located adjacent to the bottom surface 124 of the light guide plate 12, and includes two transformers 162 and a PWM 164 thereat.

The light tubes 14 are aligned in parallel, and each first electrode 142 of one of the light tubes 14 is aligned with a second electrode 144 of the other one of the light tubes 14. Each first electrode 142 is aligned with a corresponding second electrode 144. The first electrodes 142 are each electrically connected one of the transformers 162, thus providing the first electrodes 142 with high voltage electricity. The second electrodes 144 are electrically connected with the PMW 164, which provides low voltage electricity to each of the second electrodes 144.

In operation, when the backlight module 10 is in a working state, brightness and temperatures around the first electrodes 142 of the respective light tubes 14 are higher than those around the second electrodes 144 thereof. However, the first electrodes 142 are aligned with the second electrodes 144, thereby balancing the brightness and the temperatures of the first electrodes 142 and the second electrodes 144. That is, the light tubes 14 can cooperatively provide uniform emission of light for the backlight module 10. Furthermore, heat generated by the light tubes 14 around the first electrodes 142 can be dissipated at a faster rate, thus extending a working life of each light tube 14.

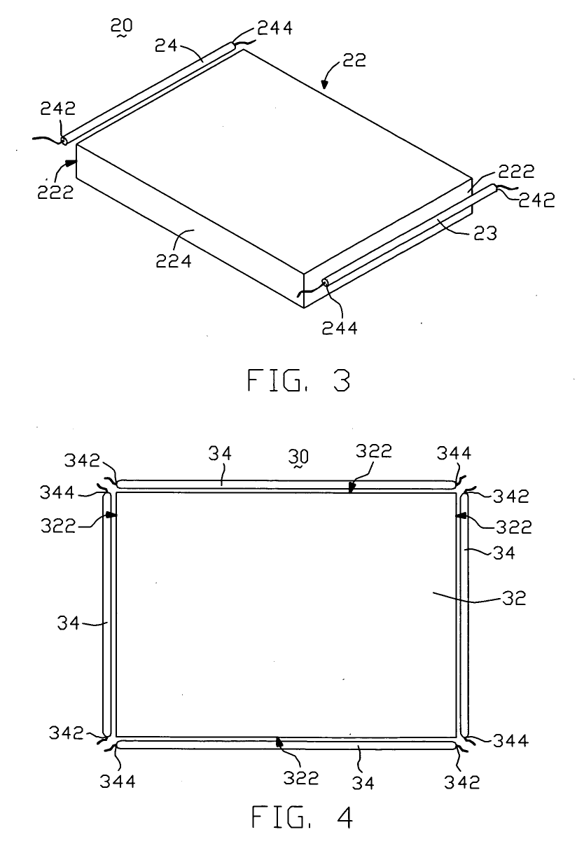

Referring to FIG. 3, a backlight module 20 according to a second embodiment of the present invention is similar to the backlight module 10. However, the backlight module 20 includes a light guide plate 22, a first linear light tube 23, and a second linear light tube 24. The light guide plate 22 includes two light incident surfaces 222 on opposite sides of the light guide plate 22. Two side surfaces 224 on opposite sides of the light guide plate 22 perpendicularly connect with the light incident surfaces 222. The first light tube 23 and the second light tubes 24 are located adjacent to the light incident surfaces 222 and are aligned parallel to each other. Each of the first light tubes 23 and the second light tubes 24 includes a first electrode 242 electrically connected with a high voltage electricity supply at an end thereof, and a second electrode 244 electrically connected with a low voltage electricity supply at the other end thereof. The first electrodes 242 of the first light tubes 23 and the second electrodes 244 of the second light tubes 24 are aligned to point to one of the side surfaces 224, and the second electrodes 244 of the first light tubes 23 and the first electrodes 244 of the second light tubes 24 are aligned to point to the other one of the side surfaces 224. That is, the first electrodes 242 of the light tubes 23, 24 respectively point toward opposite side surfaces. Thus the backlight module 20 can achieve uniform emission of light from the light tubes 24, and a working life of each of the light tubes 23, 24 can be further extended.

Referring to FIG. 4, a backlight module 30 according to a third embodiment of the present invention is similar to the backlight module 20. However, the backlight module 30 includes a light guide plate 32, and four linear light tubes 34. The light guide plate 32 includes four light incident surfaces 322 connected end to end. The light tubes 34 are located adjacent to their respective light incident surfaces 322, contacting with their light incident surfaces end to end. Each light tube 34 includes a first electrode 342 electrically connected with a high voltage electricity source at an end thereof, and a second electrode 344 electrically connected with a low voltage electricity source at the other end thereof. Each first electrode 342 of one of the light tubes 34 is aligned with a corresponding second electrode 344 of an adjacent one of the light tubes 34. The backlight module 30 has advantages similar to those of the above-described backlight module 20.

Referring to FIG. 5, a backlight module 40 according to a fourth embodiment of the present invention is similar to the backlight module 30. However, the backlight module 40 includes a light guide plate 42, and three light tubes 44. The light guide plate 42 has a substantially hexagonal shape. The light guide plate 42 includes six light incident surfaces 422, and defines three cutouts 424 at three non-adjacent corners (not labeled) thereof. Each light tube 44 is substantially V-shaped with a curved corner 446. The light tubes 44 are located adjacent to the light guide plate 42, and are positioned and orientated end-to-end. Each light tube 44 is located adjacent to two adjacent light incident surfaces 422, and the curved corner 446 corresponds to one of the cutouts 424. Each light tube 44 includes a first electrode 442 electrically connected with a high voltage electricity source at one end thereof, and a second electrode 444 electrically connected with a low voltage at the other end thereof. Each first electrode 442 of one of the light tubes 44 is respectively aligned with one corresponding second electrode 444 of the adjacent one of the light tubes 44. The backlight module 40 has advantages similar to those of the above-described backlight module 30.

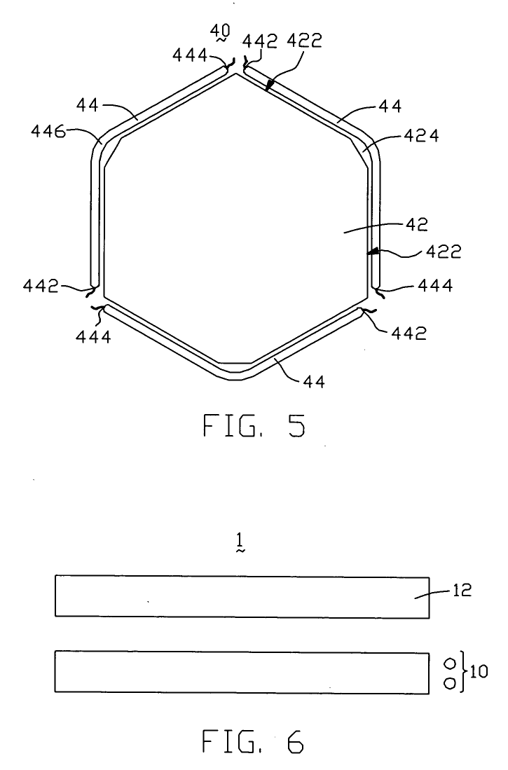

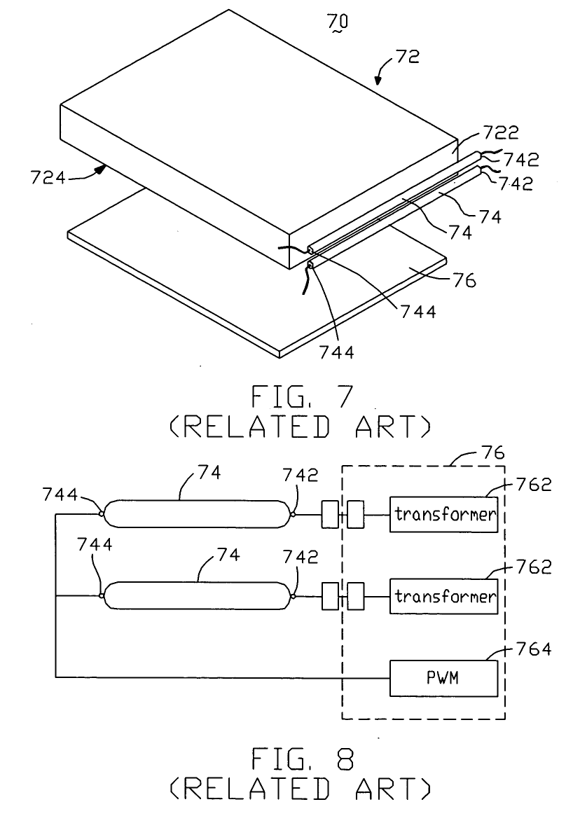

Referring also to FIG. 6, a liquid crystal display 1 according to an exemplary embodiment of the present invention is shown. The liquid crystal display 1 includes a liquid crystal panel 12, and the backlight module 10 located adjacent to the liquid crystal panel 12. In alternative embodiments, the backlight module 10 can be replaced with any one of the above-described backlight modules 20 to 40.

Further or alternative embodiments may include the following. In one example, the light tubes can be curved. In another example, the light tubes can be substantially U-shaped. In a still further example, the linear light tubes and the U-shaped light tubes can be combined as required.

It is believed that the present embodiments and their advantages will be understood from the foregoing description, and it will be apparent that various changed may be made thereto without departing from the spirit and scope of the invention or sacrificing all of its material advantages, the examples hereinbefore described merely being preferred or exemplary embodiments of the invention.

What is claimed is:

1. A backlight module comprising:
a light guide plate; and
a first light tube and a second light tube located adjacent to the light guide plate, each of the light tubes comprising:
a first electrode configured to be electrically connected with a high voltage electricity source; and
a second electrode configured to be electrically connected with a low voltage electricity source;
wherein either the first electrode of the first light tube is positioned adjacent to the second electrode of the second light tube, or, the first electrode of the first light tube is positioned at one side of the light guide plate and the second electrode of the second light tube is positioned at an opposite side of the light guide plate with the first electrode being directly across from the second electrode.

2. The backlight module in claim 1, wherein the light guide plate comprises a light incident surface, and the first light tube and the second light tube are located adjacent to the light incident surface and are oriented substantially parallel to the light incident surface.

3. The backlight module in claim 2, wherein the first electrode of the first light tube is adjacent to the second electrode of the second light tube.

4. The backlight module in claim 1, wherein the light guide plate comprises two light incident surfaces on two opposite sides thereof, and the first light tube and the second light tube are located adjacent to the light incident surfaces respectively.

5. The backlight module in claim 4, wherein the first electrode of the first light tube is positioned directly across from the second electrode of the second light tube.

6. The backlight module in claim 1, wherein the light guide plate comprises four light incident surfaces adjacent to one another end to end.

7. The backlight module in claim 6, further comprising a third light tube and a fourth light tube, wherein the first light tube, the second light tube, the third light tube, and the fourth light tube are adjacent to the light incident surfaces respectively.

8. The backlight module in claim 7, wherein the third light tube and the fourth light tube each comprise a first electrode configured to be electrically connected with the high voltage electricity source, and a second electrode configured to be electrically connected with the low voltage electricity source.

9. The backlight module in claim 8, wherein the first electrode of each of the first light tube, the second light tube, the third light tube, and the fourth light tube is adjacent to the second electrode of a corresponding adjacent one of the second light tube, the third light tube, the fourth light tube, and the first light tube.

10. The backlight module in claim 1, wherein the light guide plate is substantially hexagonal, and comprises six light incident surfaces.

11. The backlight module in claim 10, further comprising a third light tube, wherein each of the first light tube, the second light tube, and the third light tube is rectilinearly bent, and each of the first light tube, the second light tube, and the third light tube is located adjacent to a respective pair of adjacent light incident surfaces.

12. The backlight module in claim 11, wherein the third light tube comprises a first electrode configured to be electrically connected with the high voltage electricity source, and a second electrode configured to be electrically connected with the low voltage electricity source, and the first electrode of each of the first light tube, the second light tube, and the third light tube is adjacent to the second electrode of a corresponding adjacent one of the second light tube, the third light tube, and the first light tube.

13. The backlight module in claim 1, wherein the light tubes are cold cathode fluorescent lamps.

14. The backlight module in claim 1, wherein the light tubes are substantially linear.

15. The backlight module in claim 1, wherein the light tubes are substantially parallel to each other.

16. A liquid crystal display comprising:
a liquid crystal panel; and
a backlight module located adjacent to the liquid crystal panel, the backlight module comprising:
a light guide plate; and
a first light tube and a second light tube located adjacent to the light guide plate, each of the light tubes comprising:
a first electrode configured to be electrically connected with a high voltage electricity source; and
a second electrode configured to be electrically connected with a low voltage electricity source;
wherein either the first electrode of the first light tube is positioned adjacent to the second electrode of the second light tube, or, the first electrode of the first light tube is positioned at one side of the light guide plate and the second electrode of the second light tube is positioned at an opposite side of the light guide plate with the first electrode being directly across from the second electrode.

17. A backlight module comprising:
a light guide plate; and
a first light tube and a second light tube located adjacent to the light guide plate, each of the light tubes comprising:
a first electrode configured to be electrically connected with a high voltage electricity source; and
a second electrode configured to be electrically connected with a low voltage electricity source;
wherein the first electrode of the first light tube is positioned closer to the second electrode of the second light tube while farther from the first electrode of the second light tube, and the second electrode of the second light tube is positioned closer to the first electrode of the second light tube while farther from the second electrode of the second light tube under a condition that the first light tube and the second light tube are electrically connected in essentially a parallel manner.
